(19) United States
(12) Patent Application Publication
(10) Pub. No.: US 2018/0278781 A1
(43) Pub. Date: Sep. 27, 2018

(54) IMAGE FORMING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventors: Hiroshi HONDA, Kanagawa (JP); Eiji NISHI, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP); Keita SAKAKURA, Kanagawa (JP); Ryuichi ISHIZUKA, Tokyo (JP)

(73) Assignee: FUJI XEROX CO., LTD., Tokyo (JP)

(21) Appl. No.: 15/893,035

(22) Filed: Feb. 9, 2018

(30) Foreign Application Priority Data
Mar. 24, 2017 (JP) 2017-059870

(51) Int. Cl. H04N 1/00; H04N 1/32

(52) U.S. Cl. CPC H04N 1/00915; H04N 1/00344; H04N 1/32523; H04N 2201/0039; H04N 1/00058; H04N 1/00079; H04N 2201/0094; H04N 1/00037

(57) ABSTRACT

An image forming apparatus includes an image forming unit that forms an image on a recording material, an obtaining unit that obtains information from a device, which is installed in a room and obtains information regarding the room, a processing unit that generates information to be used by an external apparatus by processing the information obtained by the obtaining unit, and a transfer unit that transfers the information obtained by the obtaining unit to an external processing apparatus that processes the information.

### CROSS-REFERENCE TO RELATED APPLICATIONS

This application is based on and claims priority under 35 USC 119 from Japanese Patent Application No. 2017-059870 filed Mar. 24, 2017.

### BACKGROUND

The present invention relates to an image forming apparatus, an information processing system, and a non-transitory computer readable medium.

### SUMMARY

According to an aspect of the invention, there is provided an image forming apparatus including an image forming unit that forms an image on a recording material, an obtaining unit that obtains information from a device, which is installed in a room and obtains information regarding the room, a processing unit that generates information to be used by an external apparatus by processing the information obtained by the obtaining unit, and a transfer unit that transfers the information obtained by the obtaining unit to an external processing apparatus that processes the information.

### BRIEF DESCRIPTION OF THE DRAWINGS

An exemplary embodiment of the present invention will be described in detail based on the following figures, wherein:

FIG. 1 is a diagram illustrating the overall configuration of an office environment management system;

FIG. 2 is a diagram illustrating the hardware configuration of first to third image forming apparatuses;

FIG. 3 is a diagram illustrating functional units of the respective image forming apparatuses achieved by a central processing unit (CPU) or the like of the respective image forming apparatuses;

FIG. 4 is a diagram illustrating the hardware configuration of a management server; and

FIG. 5 is a flowchart illustrating a process performed by each of the first to third image forming apparatuses.

### DETAILED DESCRIPTION

An exemplary embodiment of the present invention will be described hereinafter with reference to the accompanying drawings.

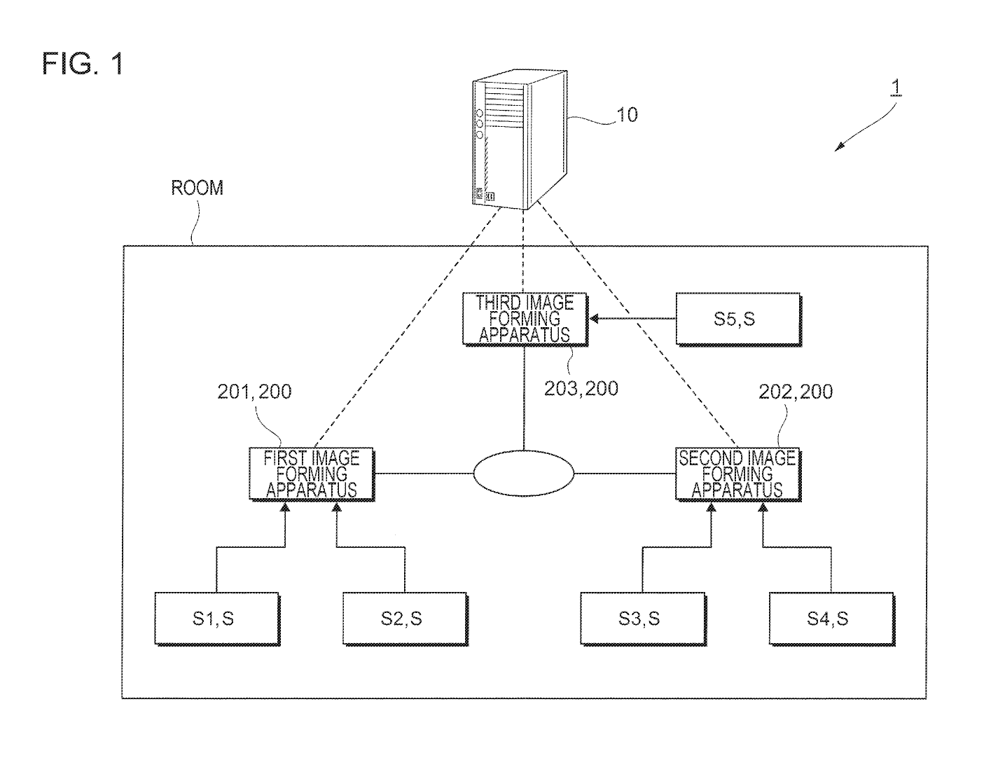

FIG. 1 is a diagram illustrating the overall configuration of an office environment management system 1.

In the office environment management system 1 as an example of an information processing system, a management server 10 as an example of an external apparatus is provided on a cloud.

Image forming apparatuses 200 are also provided in the office environment management system 1. More specifically, three image forming apparatuses 200, namely first to third image forming apparatuses 201 to 203, are provided. The first to third image forming apparatuses 201 to 203 are connected to one another through a communication network such as a local area network (LAN) and communicate information with one another.

The image forming apparatuses 200 each have a facsimile function and a scanner function, as well as a function of forming an image on a recording material such as a sheet of paper.

The image forming apparatuses 200 are connected to the management server 10 through a communication network such as the Internet. The image forming apparatuses 200 are installed in the same room (office).

Although a case in which all the image forming apparatuses 200 are installed in the same room will be described in the present exemplary embodiment, the image forming apparatuses 200 may be installed in different rooms, instead.

Furthermore, in the office environment management system 1 according to the present exemplary embodiment, sensors S are provided in the room. The sensors S as an example of devices are provided in the room and obtain information regarding the room. The sensors S output the obtained information to the corresponding image forming apparatuses 200.

More specifically, in the present exemplary embodiment, five sensors S, namely first to fifth sensors S1 to S5, are provided. In the present exemplary embodiment, the first and second sensors S1 and S2 are connected to the first image forming apparatus 201 and output information (hereinafter referred to as “sensor data”) obtained thereby to the first image forming apparatus 201.

The third and fourth sensors S3 and S4 are connected to the second image forming apparatus 202 and output sensor data obtained thereby to the second image forming apparatus 202.

The fifth sensor S5 is connected to the third image forming apparatus 203 and outputs sensor data obtained thereby to the third image forming apparatus 203.

Upon receiving sensor data from the sensors S, the first to third image forming apparatuses 201 to 203 perform a predetermined process (e.g., preprocessing such as noise removal or event detection) on the sensor data and transmits the sensor data to the management server 10.

The management server 10 identifies a situation in the room, for example, on the basis of the sensor data transmitted from the image forming apparatuses 200. If determining that the situation in the room is a predetermined situation, for example, the management server 10 changes settings of an air conditioner in the room or notifies a manager of the situation.

The sensors S may include, for example, a temperature sensor that measures temperature, a humidity sensor that measures humidity, and an illuminance sensor that measures illuminance. The sensors S may also include a person detection sensor that detects a person in the room, such as an infrared sensor.

The sensors S transmit obtained sensor data to the corresponding image forming apparatuses 200 through wireless or wired communication. The image forming apparatuses 200 then transmit the sensor data received from the sensors S to the management server 10.

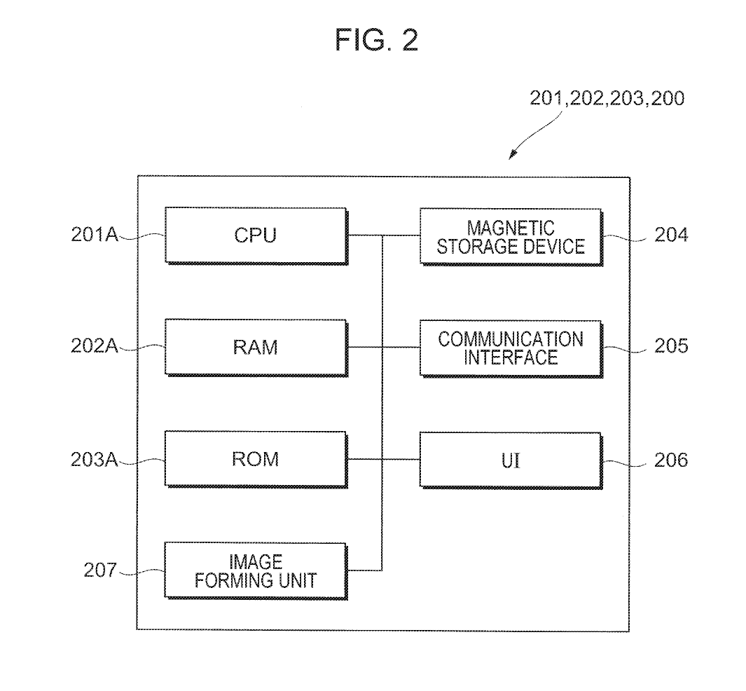

FIG. 2 is a diagram illustrating the hardware configuration of the first to third image forming apparatuses 201 to 203.

As illustrated in FIG. 2, the first to third image forming apparatuses 201 to 203 each include a CPU 201A, a random-access memory (RAM) 202A, a read-only memory (ROM) 203A, and a magnetic storage device 204. The first to third image forming apparatuses 201 to 203 each also include a communication interface 205 for communicating with the outside.

The first to third image forming apparatuses 201 to 203 each also include a user interface (UI) 206 and an image forming unit 207.

The UI 206 is configured, for example, by a touch panel display. The UI 206 receives information to be displayed and displays (provides) the information to the user. The UI 206 also receives operations performed by a user.

The image forming unit 207 as an example of an image forming unit forms an image on a sheet of paper, which is an example of the recording material, using an electrophotographic method or an inkjet method.

The ROM 203A and the magnetic storage device 204 store programs to be executed by the CPU 201A. The CPU 201A reads the programs stored in the ROM 203A and the magnetic storage device 204 and executes the programs using the RAM 202A as a working area.

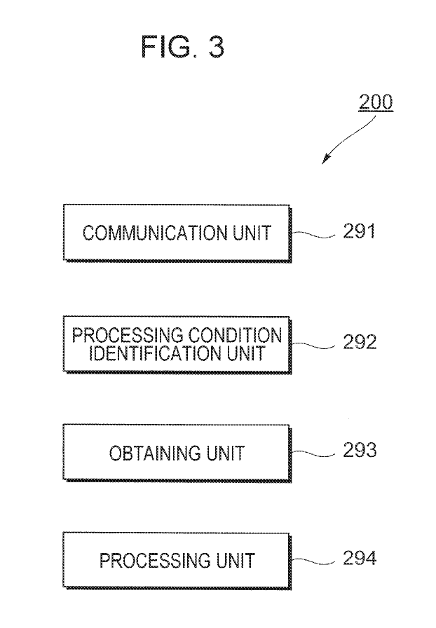

By executing the programs stored in the ROM 203A and the magnetic storage device 204 using the CPU 201A, functional units (described later) illustrated in FIG. 3 are achieved.

The programs to be executed by the CPU 201A can be stored in a computer readable recording medium, such as a magnetic recording medium (a magnetic tape, a magnetic disk, etc.), an optical recording medium (an optical disc, etc.), a magneto-optical recording medium, or a semiconductor memory, and provided for the first to third image forming apparatuses 201 to 203. The programs to be executed by the CPU 201A may be downloaded to the first to third image forming apparatuses 201 to 203 through a communication network such as the Internet.

FIG. 3 is a diagram illustrating the functional units of the image forming apparatuses 200 achieved by the CPUs 201A of the image forming apparatuses 200.

The image forming apparatuses 200 each include a communication unit 291. The communication unit 291 is configured by the CPU 201A and the communication interface 205 of each of the image forming apparatuses 200, for example, and communicates information.

More specifically, for example, the communication unit 291 receives information from the corresponding sensors S. The communication unit 291 also receives information from the other image forming apparatuses 200 and the management server 10. In addition, the communication unit 291 transmits information to the management server 10. The communication unit 291 also functions as a transfer unit and transfers sensor data to the other image forming apparatuses 200, which are an example of external processing apparatuses.

The image forming apparatuses 200 each also include a processing condition identification unit 292 as an example of an identification unit.

The processing condition identification unit 292 identifies a processing condition of the image forming apparatus 200. The processing condition identification unit 292 also identifies processing conditions of the other image forming apparatuses 200.

The processing condition identification unit 292 identifies the processing conditions of the other image forming apparatuses 200 on the basis of information transmitted from the other image forming apparatuses 200 (information obtained by the processing condition identification units 292 of the other image forming apparatuses 200 and transmitted from the other image forming apparatuses 200).

The image forming apparatuses 200 each also include an obtaining unit 293 that obtains sensor data. The obtaining unit 293 as an example of an obtaining unit obtains sensor data from the corresponding sensors S provided in the room. The image forming apparatuses 200 each also include a processing unit 294 as an example of a processing unit.

The processing unit 294 generates information to be used by the management server 10 as an example of the external apparatus by performing a predetermined process on sensor data obtained by the obtaining unit 293. In other words, the processing unit 294 generates information to be output to the management server 10 by processing sensor data obtained by the obtaining unit 293.

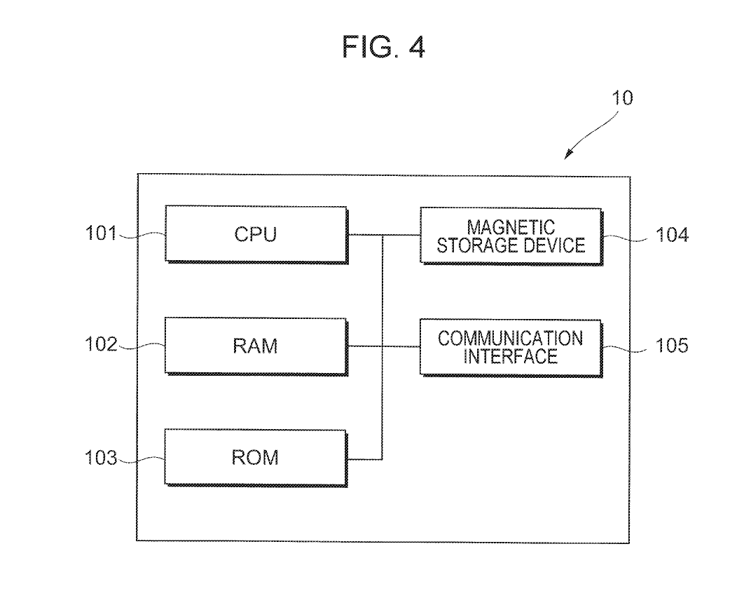

FIG. 4 is a diagram illustrating the hardware configuration of the management server 10.

As illustrated in FIG. 4, the management server 10 includes a CPU 101, a RAM 102, a ROM 103, and a magnetic storage device 104. The management server 10 also includes a communication interface 105 for communicating with the outside.

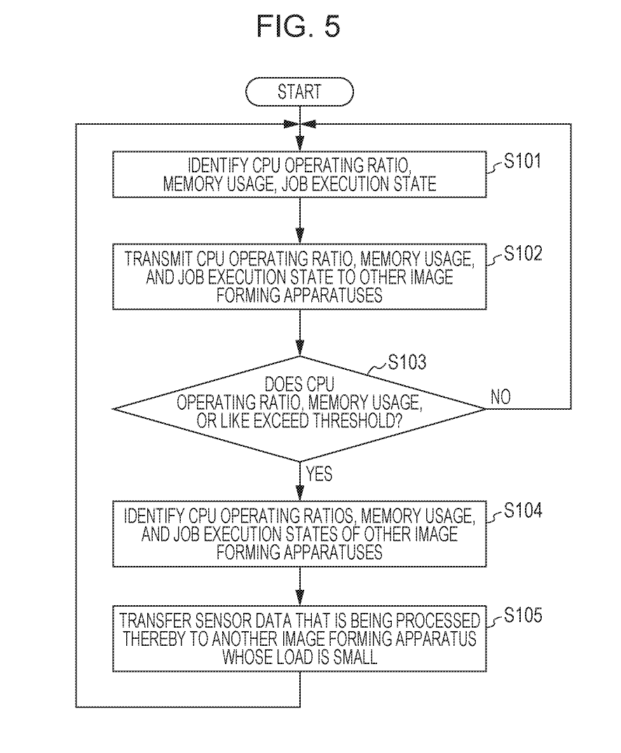

FIG. 5 is a flowchart illustrating a process performed by the first to third image forming apparatuses 201 to 203.

The processing condition identification unit 292 of each of the first to third image forming apparatuses 201 to 203 identifies an operating ratio of the CPU 201A provided for the image forming apparatus 200, memory usage, and a job execution state (step S101).

The communication unit 291 of each of the first to third image forming apparatuses 201 to 203 then transmits information (hereinafter referred to as “condition information”) obtained in step S101 to the other image forming apparatuses 200 at predetermined timings (step S102). As a result, the processing condition identification unit 292 of each of the image forming apparatuses 200 can identify the processing conditions of the other image forming apparatuses 200.

In the present exemplary embodiment, the sensors S sequentially output sensor data to the corresponding image forming apparatuses 200. The processing unit 294 of each of the image forming apparatuses 200 sequentially processes the sensor data, and the processed sensor data is sequentially transmitted to the management server 10.

After step S102, the processing condition identification unit 292 of each of the image forming apparatuses 200 determines whether a value identified from the condition information obtained in step S101 exceeds a predetermined threshold (step S103).

If determining in step S103 that the value exceeds the predetermined threshold, the processing condition identification unit 292 identifies the processing conditions (load conditions) of the other image forming apparatuses 200 (step S104) and finds an image forming apparatus 200 whose processing load is small.

Next, in the present exemplary embodiment, the communication unit 291 as an example of the transfer unit transfers (transmits) the sensor data, which is information sequentially output from the corresponding sensors S, to the image forming apparatus 200 whose processing load is small (step S105).

More specifically, the communication unit 291 transfers the sensor data, which is the information from the corresponding sensors S, to an image forming apparatus 200 with the smallest processing load (an image forming apparatus 200 that can process the sensor data most promptly; at least one of the image forming apparatuses 200) among the image forming apparatuses 200.

In the present exemplary embodiment, the processing unit 294 of the image forming apparatus 200 with the smallest processing load then processes the transferred sensor data.

In other words, in the present exemplary embodiment, if a load of an image forming apparatus 200 that has received sensor data from the corresponding sensors S is small, the image forming apparatus 200 processes the sensor data and transmits a result of the processing to the management server 10.

If a load of an image forming apparatus 200 that has received sensor data is large (if the load of the image forming apparatus 200 is large due to image processing, a process for forming an image, or the like performed by the image forming apparatus 200), on the other hand, the image forming apparatus 200 transfers the sensor data to the image forming apparatuses 200 whose load is small. The image forming apparatus 200 whose load is small then processes the sensor data.

If sensor data from corresponding sensors S is processed only by an image forming apparatus 200, and if a processing load of the image forming apparatus 200 is large, the sensor data might not be processed or the processing might be delayed.

In the present exemplary embodiment, on the other hand, if sensor data might not be processed or processing might be delayed, the sensor data is transferred to another image forming apparatus 200 whose processing load is small, and this image forming apparatus 200 processes the sensor data.

If the processing condition identification unit 292 does not determine in step S103 that the value identified from the condition information does not exceed the predetermined threshold, step S101 and later steps are performed again.

In addition, if sensor data is transferred to another image forming apparatus 200 (an example of a second information processing apparatus; hereinafter referred to as a “destination apparatus”) as described above, the destination apparatus may directly transmit the sensor data subjected to processing (the sensor data processed by the processing unit 294 of the destination apparatus; hereinafter referred to as “processed sensor data”) to the management server 10.

Alternatively, the destination apparatus may transmit the processed sensor data to a source image forming apparatus 200 (an example of a first information processing apparatus; hereinafter referred to as a “source apparatus”), and the processed sensor data may be transmitted to the management server 10 from the source apparatus.

In addition, in the present exemplary embodiment, when a source apparatus transfers sensor data to a destination apparatus, the source apparatus transmits the sensor data to the destination apparatus while associating the sensor data with identification information regarding sensors S that have output the sensor data and timestamps (information regarding timings at which the information has been output from the sensors S).

In this case, the destination apparatus or the management server 10 to which the sensor data is transmitted sorts out the sensor data or the processed sensor data on the basis of the identification information and the timestamps. As a result, the destination apparatus or the management server 10 can collect sensor data or processed sensor data for each sensor S and arrange the sensor data or the processed sensor data in chronological order.

As described above, in the present embodiment, a destination apparatus might directly transmit processed sensor data to the management server 10. In this case, the processed sensor data generated from information originated from a single sensor S can be transmitted to the management server 10 through a source apparatus and the destination apparatus.

In this case, if identification information and timestamps are not transmitted to the management server 10, it is difficult for the management server 10 to manage the processed sensor data.

If identification information and timestamps are transmitted as in the present exemplary embodiment, on the other hand, the management server 10 can manage processed sensor data for each sensor S in chronological order.

In addition, if a destination apparatus directly transmits processed sensor data to the management server 10 (if the destination apparatus transmits the processed sensor data to the management server 10 without using a source apparatus), the management server 10 that has received the processed sensor data may transmit the processed sensor data to the source apparatus.

Here, it is assumed, for example, that the user refers to the processed sensor data by operating the UI 206 (refer to FIG. 2) of the source apparatus. In this case, if the destination apparatus is configured to directly transmit the processed sensor data to the management server 10, the processed sensor data is not stored in the source apparatus, and it is difficult for the UI 206 of the source apparatus to refer to the processed sensor data.

If the management server 10 transmits processed sensor data to a source apparatus as in the present exemplary embodiment, on the other hand, the UI 206 of the source apparatus can refer to the processed sensor data.

When a source apparatus transfers sensor data to a destination apparatus, a part, not the entirety, of the sensor data may be transferred.

When a sensor S outputs a series of data, for example, a load of a source apparatus that has been small at a beginning of the outputting of the data might become large during the outputting of the data.

In this case, the source apparatus processes the sensor data until the load becomes large, for example, and if the load becomes large, the sensor data may be transferred to a destination apparatus.

Although a case in which a load of a source apparatus is small has been described above, a load of a source apparatus might be large.

In this case, the source apparatus need not transfer sensor data, for example, and may process the sensor data. More specifically, in this case, the source apparatus may sequentially process sensor data from a sensor S (predetermined sensor S) whose priority is high. The source apparatus may store, in a memory, sensor data from another sensor S whose priority is low and begin to process the sensor data from the sensor S whose priority is low after the processing of the sensor data from the sensor S whose priority is high is completed. In this case, the sensor data from the sensor S whose priority is low may be discarded.

Degrees of priority of the sensors S are registered to the corresponding image forming apparatuses 200 in advance, and the order of priority is determined on the basis of the registered degrees of priority.

A degree of importance might be different between the sensors S. For example, a temperature sensor S might have a higher degree of importance than a humidity sensor S or an illuminance sensor S.

If a fire starts in the room, for example, the temperature sensor S can detect the fire, but the humidity sensor S or the illuminance sensor S might not exhibit abnormal values. In this case, if the priority of processing of sensor data has not been determined, for example, sensor data from the humidity sensor S or the illuminance sensor S might be processed first, and it might take time to detect the fire.

If the degrees of priority are given to the sensors S and the temperature sensor S is given priority, such an inconvenience can be suppressed.

In addition, if a degree of priority (a degree of emergency) of a sensor S that has output sensor data is high, such as when the temperature sensor S has output sensor data, other processes (such as a process relating to image formation) being performed by a corresponding image forming apparatus 200 may be delayed, and the sensor data may be processed first.

In addition, sensor data may be transferred to only some of destination apparatuses.

If there are five image forming apparatuses 200, for example, two of the five image forming apparatuses 200 may be used as destination apparatuses, and information may be transferred to one of the two image forming apparatuses 200.

In this case, the other three image forming apparatuses 200 do not frequently process sensor data and tend to enter a power-saving mode. Compared to when all the five image forming apparatuses 200 are used to process sensor data, overall power consumed by the system can be reduced.

In addition, a processing program used to process sensor data may be transferred between the image forming apparatuses 200. This is because corresponding sensors S might be different between the image forming apparatuses 200, and each of the image forming apparatuses 200 might store only processing programs for processing sensor data from the corresponding sensors S.

If a processing program used to process sensor data is transmitted between the image forming apparatuses 200, that is, if a source apparatus transmits a processing program for processing sensor data to a destination apparatus, any image forming apparatus 200 can process sensor data from the source apparatus.

If a load of a destination apparatus is large when a source apparatus transfers sensor data to the destination apparatus, the transfer of the sensor data may be delayed.

Furthermore, the image forming apparatuses 200 may estimate a resource necessary to process sensor data. More specifically, if a new sensor S is provided, each of the image forming apparatuses 200 requires a resource according to the sensor S. In this case, the image forming apparatuses 200 may estimate a resource by measuring increases in a CPU operating ratio and memory usage in unit time in accordance with a type of new sensor S.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a recording material;
an obtaining unit that obtains information from a device, which is installed in a room and obtains information regarding the room;
a processing unit that generates information to be used by an external apparatus by processing the information obtained by the obtaining unit; and
a transfer unit that transfers the information obtained by the obtaining unit to one or more external processing apparatuses that process the information.

2. The image forming apparatus according to claim 1,
wherein, if the processing performed by the processing unit is delayed, the transfer unit transfers the information to the one or more external processing apparatuses.

3. The image forming apparatus according to claim 1,
wherein the one or more external processing apparatuses include a plurality of external processing apparatuses, and the transfer unit transfers the information to at least one of the plurality of external processing apparatuses.

4. The image forming apparatus according to claim 3,
wherein the transfer unit transfers the information to an external processing apparatus that processes the information most promptly among the plurality of external processing apparatuses.

5. The image forming apparatus according to claim 1, further comprising:
an identification unit that identifies a condition relating to a load of the one or more external processing apparatuses, to which the information is transferred.

6. The image forming apparatus according to claim 1,
wherein a plurality of devices are installed in the room, and
wherein the processing unit gives priority to processing of information from a predetermined one of the plurality of devices over processing of information from the other devices.

7. The image forming apparatus according to claim 6,
wherein the plurality of devices include a temperature sensor, and
wherein the processing unit gives priority to processing of information from the temperature sensor over processing of information from the other devices.

8. The image forming apparatus according to claim 1,
wherein the processing unit not only processes the information from the device but also performs a process relating to image formation,
wherein a plurality of devices are installed in the room, and
wherein the processing unit gives priority to processing of information from a predetermined one of the plurality of devices over the process relating to image formation.

9. An information processing system comprising:
a device installed in a room;
a first information processing apparatus including an obtaining unit that obtains information from the device installed in the room, a processing unit that generates information to be used by an external apparatus by processing the information obtained by the obtaining unit, and a transfer unit that transfers the information obtained by the obtaining unit; and
a second information processing apparatus that generates information to be used by the external apparatus by processing the information transferred from the transfer unit of the first information processing apparatus.

10. The information processing system according to claim 9,
wherein the first information processing apparatus is installed in the room in which the device is installed.

11. The information processing system according to claim 9,
wherein the first information processing apparatus and the second information processing apparatus are each configured by an image forming apparatus that forms an image on a recording material.

12. The information processing system according to claim 9,
wherein the information to be used by the external apparatus generated by the second information processing apparatus is transmitted to the first information processing apparatus, and then to the external apparatus.

13. The information processing system according to claim 9,
wherein the information to be used by the external apparatus generated by the second information processing apparatus is transmitted to the external apparatus from the second information processing apparatus without using the first information processing apparatus, and
wherein the information to be used by the external apparatus transmitted from the second information processing apparatus to the external apparatus is transmitted to the first information processing apparatus from the external apparatus.

14. The information processing system according to claim 9,
wherein the first information processing apparatus transmits, to the second information processing apparatus, a program to be used to process the information from the device.

15. A non-transitory computer readable medium storing a program causing a computer to execute a process comprising:
obtaining information from a device, which is installed in a room and obtains information regarding the room;
generating information to be used by an external apparatus by processing the information obtained in the obtaining; and
transferring the information obtained in the obtaining to an external processing apparatus that processes information.
